(19) United States
(12) Patent Application Publication
(10) Pub. No.: US 2007/0173250 A1
(43) Pub. Date: Jul. 26, 2007

(54) Apparatus and method for preventing call from being dropped in mobile communication system

(75) Inventors: Sang-Hyun Lee, Seoul (KR); Yeon-Suk Choi, Daejon (KR); Jo-En Sung, Anyang-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/650,854

(22) Filed: Jan. 8, 2007

(30) Foreign Application Priority Data
Jan. 6, 2006 (KR) 10-2005-0001895

(51) Int. Cl. H04Q 7/20

(52) U.S. Cl. 455/423

(57) ABSTRACT

Disclosed is an apparatus for preventing a call from being dropped in a mobile communication system, including a Mobile Station (MS) for reporting a temporal reception-impossible mode to a network if the MS enters a temporal reception-impossible state in a state where a call has been connected, and maintaining a Radio Link Timeout (RLT) value during a preset time period; and the network for maintaining the call with the MS during a preset time period after the temporal reception-impossible mode is reported from the MS. According to the apparatus, a call is maintained during a preset time period when an MS is in a temporal reception-impossible state, so that it is possible to prevent a call from being dropped.

### PRIORITY

This application claims priority to an application entitled “Apparatus And Method For Preventing Call From Being Dropped In Mobile Communication System” filed in the Korean Intellectual Property Office on Jan. 6, 2006 and assigned Serial No. 2006-1895, the contents of which are incorporated herein by reference.

### BACKGROUND OF THE INVENTION

1. Field of the Invention

The present invention relates to a mobile communication system, and more particularly to an apparatus and a method for preventing a call from being dropped in a Global System for Mobile (GSM) system.

2. Description of the Related Art

A GSM system corresponds to a digital mobile telephone system using Time Division Multiple Access (TDMA) technology that is the most widely used digital wireless telephone technology together with Code Division Multiple Access (CDMA) technology. A GSM system digitizes and compresses data, and transmits the compressed data through one channel together with two different user data wherein respective data are transmitted in specific time zones.

Such a GSM system maps a logical channel to a physical channel such as an RF channel, a TDMA frame and a time slot. The logical channel may include a Traffic Channel (TCH) and a control channel such as a BCCH, a PCH, a RACH, a Slow Associated Control Channel (SACCH) and a FACCH. Herein, information including voice, data, etc., is transmitted through a TCH, and control signals between a Base Transceiver Station (BTS) and a plurality of Mobile Stations (MSs) are transmitted through a control channel.

A SACCH is a channel used to transmit/receive control information between one BTS and one MS, and is used for transmission/reception of system information and handoff-related information. A SACCH is used in connection with a TCH. An MS sends received signal quality information, Broadcast Channel (BCH) power measurement information, which corresponds to a set of logical channels of links used for synchronization with an adjacent cell, etc., to a BTS through a SACCH during communication. Further, a BTS sends transmitted signal power information of an MS, timing information, channel configuration information of a cell, etc., through a downlink SACCH during communication.

An MS and a BTS perform radio link control for communication while periodically exchanging the afore-described SACCH block during communication. If the SACCH block is not normally received, a call drop may occur because communication cannot be performed. Herein, a call drop represents that communication is interrupted by external conditions, instead of a user request, after an MS originates a call, a BTS assigns a voice channel, and the line of a trunk device in a Mobile Switching Center (MSC) is assigned to the call.

In conventional systems, an MS has a Radio Link Timeout (RLT) value for call drop determination, as in GSM Specification 05.08 5.2. That is, if the reception of a SACCH block is successful during communication, the RLT value increases by two. However, if the reception of the SACCH block fails during communication, the RLT value decreases by one, and the call is dropped when the RLT value becomes zero.

However, according to the conventional call drop method as described above, a call may also be dropped when a SACCH block is not temporarily received in an elevator, a tunnel, etc., instead of when a SACCH block cannot be generally received. Therefore, since a call may be dropped even when a user temporarily passes through an elevator, a tunnel, etc., the user must reconnect communication after passing through the elevator, the tunnel, etc.

### SUMMARY OF THE INVENTION

Accordingly, the present invention has been made to solve the above-mentioned problems occurring in conventional systems, and it is an object of the present invention to provide an apparatus and a method for preventing a call from being dropped in a mobile communication system, which prevents a call from being dropped when a SACCH block is not temporarily received.

It is another object of the present invention to provide an apparatus and a method for preventing a call from being dropped in a mobile communication system, which prevents a call from being dropped when a user expects that a SACCH block will not be temporarily received or when a reception level RX_LEVEL rapidly deteriorates.

In accordance with one aspect of the present invention, there is provided an apparatus for preventing a call from being dropped in a mobile communication system, the apparatus including a Mobile Station (MS) for reporting a temporal reception-impossible mode to a network if the MS enters a temporal reception-impossible state in a state where a call has been connected, and maintaining a Radio Link Timeout (RLT) value during a preset time period; and the network for maintaining the call with the MS during a preset time period after the temporal reception-impossible mode is reported from the MS.

In accordance with another aspect of the present invention, there is provided a method for preventing a call from being dropped in a mobile communication system, the method including reporting by a Mobile Station (MS) a temporal reception-impossible mode to a network if the MS enters a temporal reception-impossible state in a state where a call has been connected, and maintaining a Radio Link Timeout (RLT) value during a preset time period; and maintaining by the network the call with the MS during a preset time period after the temporal reception-impossible mode is reported from the MS.

In accordance with further another aspect of the present invention, there is provided a method for preventing a call of a Mobile Station (MS) from being dropped in a mobile communication system, the method including determining if the MS enters a temporal reception-impossible state in a state where a call has been connected; reporting a temporal reception-impossible mode to a network if the MS enters the temporal reception-impossible state; and maintaining a Radio Link Timeout (RLT) value during a preset time period in the temporal reception-impossible mode.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of a mobile communication system according to the present invention;

FIG. 2 is a flowchart illustrating a method for preventing a call from being dropped in a mobile communication system according to the present invention;

FIG. 3 is a flowchart illustrating a process for determining if an MS is in a temporal reception-impossible state according to the present invention;

FIG. 4A is a diagram illustrating measurement results according to the conventional systems; and

FIG. 4B is a diagram illustrating measurement results according to the present invention.

### DETAILED DESCRIPTION OF THE PREFERRED EMBODIMENTS

Preferred embodiments of the present invention will be described in detail herein below with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

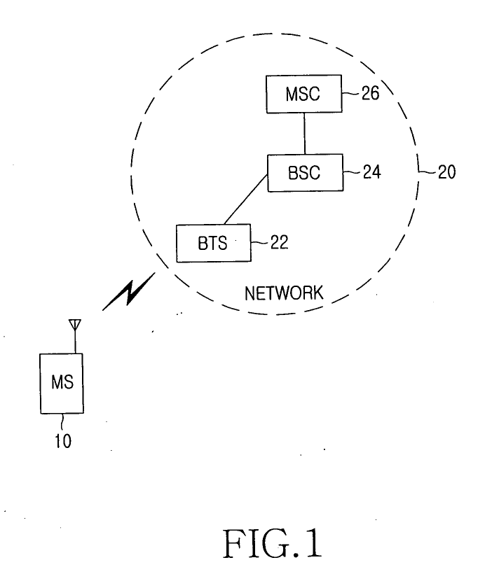

FIG. 1 is a block diagram illustrating the construction of a mobile communication system according to an embodiment of the present invention. Referring to FIG. 1, the mobile communication system according to the present invention includes an MS 10 and a network 20.

The MS 10 performs communication utilizing a SACCH block transmitted from a BTS 22, and determines if the MS 10 is in a temporal reception-impossible state when a call has been connected. The temporal reception-impossible state represents a state where the MS 10 temporarily cannot receive the SACCH block. For example, the temporal reception-impossible state may include a state where a RX_LEVEL rapidly falls below a threshold value as the MS 10 passes through an elevator, a tunnel, etc.

If the MS 10 is in the temporal reception-impossible state, the MS 10 enters a temporal reception-impossible mode, and reports the temporal reception-impossible mode to the network 20 through the BTS 22. Further, the MS 10 maintains an RLT value as a value before the temporal reception-impossible mode for a preset time period.

In other words, in the temporal reception-impossible mode, the MS 10 maintains an RLT value for a preset time period, instead of increasing or decreasing the RLT value according to whether a SACCH block has been successfully received. Then, if the preset time period passes, the MS 10 releases the temporal reception-impossible mode and increases or decreases the RLT value according to whether the SACCH block has been successfully received.

Herein, if a call is released before the preset time period has elapsed, the MS 10 increases or decreases the RLT value according to whether the SACCH block has been successfully received. Further, when communication is terminated by a user, a call may be released between the MS 10 and the network 20. Furthermore, when data are not received from the MS 10 for a preset time period, a call may be released to free network 20 resources.

The network 20 includes a BTS 22, a BSC 24 and an MSC 26. The MSC 26 takes charge of mobility management, location registration/management, authentication, handover, roaming, etc. The BSC 24 manages a plurality of BTSs 22, sets up a radio channel, and connects the BTS 22 and the MSC 26. The BTS 22 is connected to the BSC 24 and connects calls to the MS 10 through a radio link.

In a communication state, the above-described network 20 periodically transmits a SACCH block to the MS 10 through the BTS 22, thereby allowing call connection to be maintained. In a state in which the call connection has been maintained, if a temporal reception-impossible mode is reported from the MS 10, the network 20 determines that the MS 10 is in the temporal reception-impossible mode. If the network 20 determines that the MS 10 is in the temporal reception-impossible mode, the network 20 maintains a call with the MS 10 for a preset time period even when data are not received from the MS 10.

As described above, the network 20 and the MS 10 maintain a call for a preset time period even when a SACCH block is not temporarily received, thereby preventing the call from being dropped.

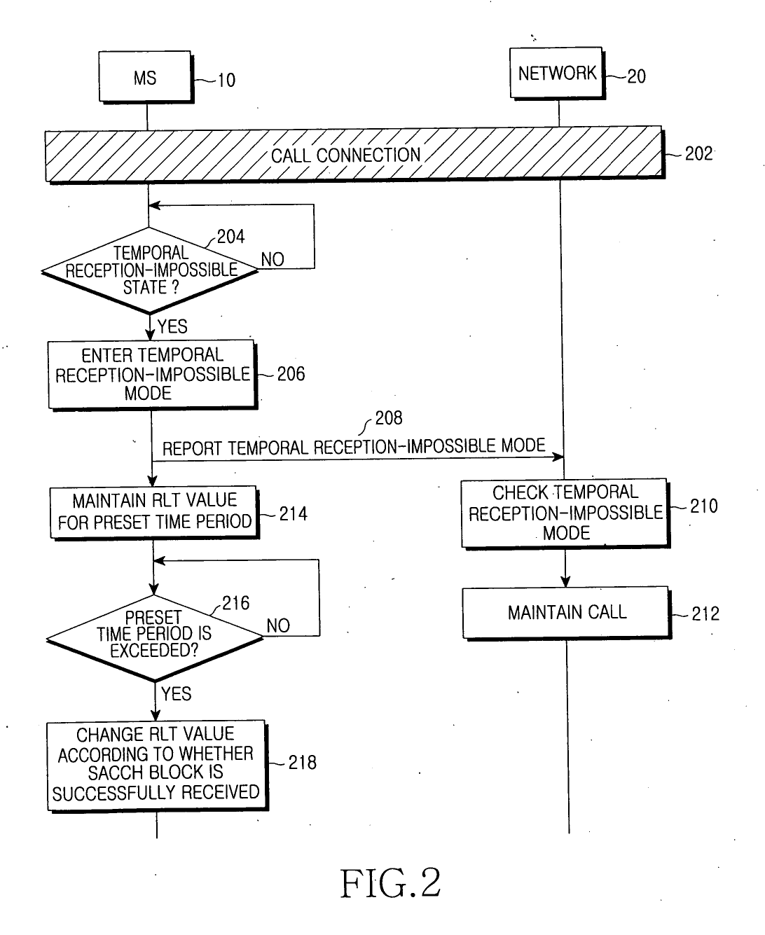

Hereinafter, a method for preventing a call from being dropped in the mobile communication system according to the present invention will be described in more detail. FIG. 2 is a flowchart illustrating the method for preventing a call from being dropped in the mobile communication system according to the present invention.

Referring to FIG. 2, the MS 10 and the network 20 connect a call according to the generation of the call, thereby communicating with each other in step 202. Herein, the MS 10 and the network 20 periodically transmit/receive a SACCH block, thereby communicating with each other.

During such communication, the MS 10 determines if the MS 10 is in a temporal reception-impossible state in step 204. The temporal reception-impossible state represents a state where the MS 10 temporarily cannot receive the SACCH block. For example, the temporal reception-impossible state may include a state where a RX_LEVEL rapidly falls below a threshold value, such as when the MS 10 passes through an elevator, a tunnel, etc.

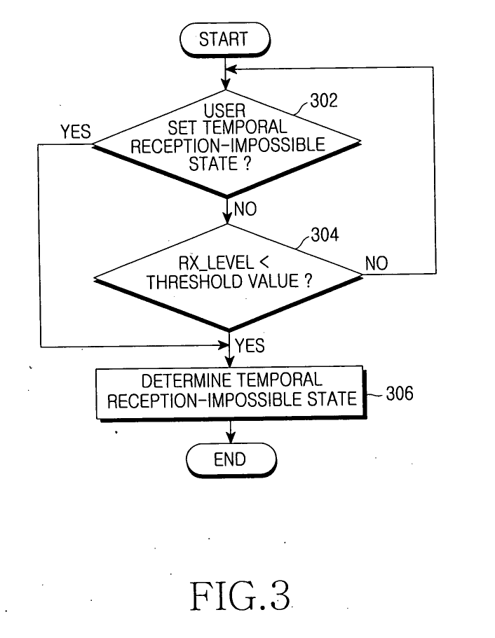

FIG. 3 is a flowchart illustrating a process for determining if the MS 10 is in the temporal reception-impossible state.

Referring to FIG. 3, in step 302, the MS 10 determines if a user sets the temporal reception-impossible state. Herein, when it is expected that the MS 10 is in the temporal reception-impossible state as the user passes the elevator, the tunnel, etc, the user can set the temporal reception-impossible state in the MS 10. If the user sets the temporal reception-impossible state, the MS 10 determines if the current state corresponds to the temporal reception-impossible state, in step 306.

However, if the user does not set the temporal reception-impossible state, the MS 10 determines if a RX_LEVEL falls below a threshold value in step 304. If the RX_LEVEL rapidly falls below the threshold value, step 306 is performed. However, if the RX_LEVEL does not fall below the threshold value, steps 302, 304 and 306 are repeated.

In this way, the MS 10 can determine if the current state corresponds to the temporal reception-impossible state.

Referring to FIG. 2 again, if the MS 10 determines that the current state corresponds to the temporal reception-impossible state, step 206 is performed. That is, the MS 10 enters a temporal reception-impossible mode.

In step 208, the MS 10 reports the temporal reception-impossible mode to the network 20. Herein, the MS 10 can report the temporal reception-impossible mode to the network 20 utilizing an existing measurement report message. The existing measurement report message corresponds to a message periodically transmitted from the MS 10 to the network 20 during communication, which includes measurement results.

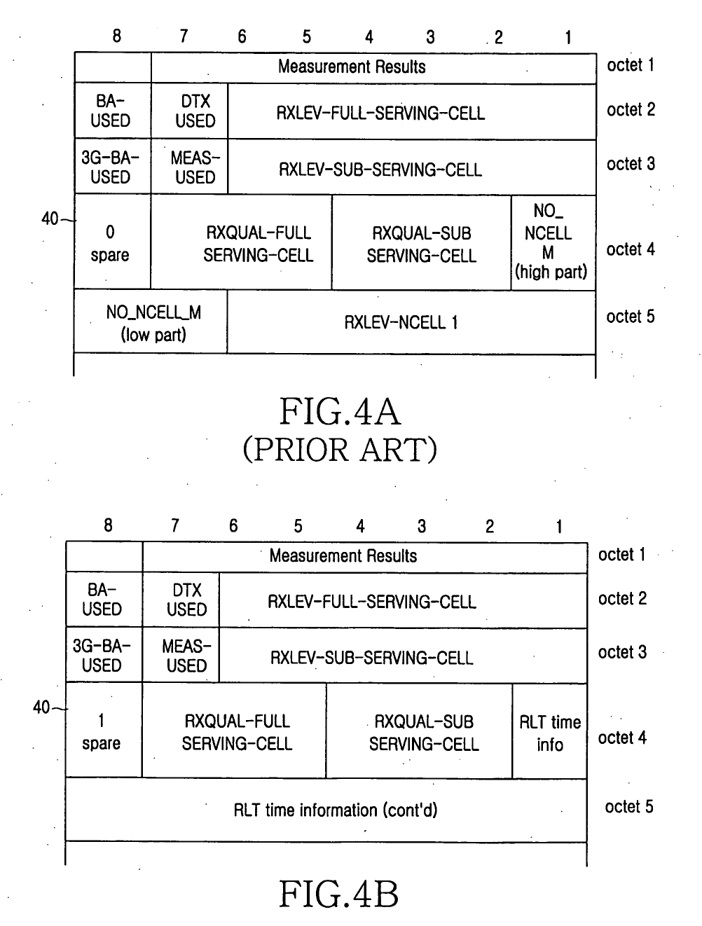

FIG. 4A is a diagram illustrating measurement results according to conventional systems, and FIG. 4B is a diagram illustrating measurement results according to the present invention.

Referring to FIG. 4A, bit 8 area 40 of octet 4 within the measurement results is a spare space (an empty space) having a value of 0, and by using total nine bits from bit 1 of the octet 4, information on a near cell is loaded in the bit 1 of the octet 4 and eight bits (bit 8 to bit 1) of octet 5 .

Referring to FIG. 4B, according to the present invention, a value of 1 is set to the bit 8 area 40 of the octet 4 within the measurement results and the temporal reception-impossible mode is reported. Instead of information on a near cell, RLT time information is included using the total nine bits from the bit 1 of the octet 4 for RLT maintenance. Herein, a preset time period for RLT maintenance is discounted by the transmission period of the measurement report message and then included therein. For example, when the transmission period (about 0.5 seconds) of the measurement report message is 104 frames, a preset time period may have a value of about 256 seconds (=0.5*512 at maximum). Whenever the measurement report message is periodically transmitted, the preset time period is discounted by 0.5 seconds and then transmitted. This allows the time for the RLT maintenance to be understood even when the measurement report message is not occasionally transmitted because it is difficult to know the time for the RLT maintenance when the measurement report message is not transferred to the network 20.

Herein, the time for maintaining the RLT intact may use a value preset by a user, and a network reflects this fact to a measurement report for counting, as described above. Accordingly, even if the measurement report is not initially received, the network can become aware of time information, which has been requested by an MS, with only one time report.

After reporting the temporal reception-impossible mode to the network 20, the MS 10 maintains an RLT value for a preset time period in step 214 of FIG. 2. In other words, the MS 10 maintains an RLT value for the preset time period, instead of increasing or decreasing the RLT value according to whether the SACCH block has been successfully received.

In step 216, the MS 10 determines if the preset time period has been exceeded. If the preset time period has been exceeded, the MS 10 releases the temporal reception-impossible mode and increases or decreases the RLT value according to whether the SACCH block has been successfully received, in step 218.

Herein, if a call is released before the preset time period is exceeded, the MS 10 may increase or decrease the RLT value according to whether the SACCH block has been successfully received. Further, when communication is terminated by a user, a call may be released between the MS 10 and the network 20. Furthermore, when data are not received from the MS 10 during a preset time period, a call may be released to free network 20 resources.

In the meantime, if the temporal reception-impossible mode is reported from the MS 10, the network 20 determines that the MS 10 is in the temporal reception-impossible mode. If the network 20 determines that the MS 10 is in the temporal reception-impossible mode, the network 20 maintains a call with the MS 10 during a preset time period even when data are not received from the MS 10, in step 212.

According to the present invention as described above, a call is maintained during a preset time period when an MS is in a temporal reception-impossible state, e.g. when an MS temporarily cannot receive a SACCH block, so that a call can be prevented from being dropped.

Further, according to the present invention as described above, when a user expects a temporal reception-impossible state or when a RX_LEVEL rapidly deteriorates, it is possible to prevent a call from being dropped.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. An apparatus for preventing a call from being dropped in a mobile communication system, the apparatus comprising:
a Mobile Station (MS) for reporting a temporal reception-impossible mode to a network if the MS enters a temporal reception-impossible state when a call has been connected, and maintaining a Radio Link Timeout (RLT) value during a preset time period; and
the network for maintaining the call with the MS during a preset time period after the temporal reception-impossible mode is reported from the MS.

2. The apparatus as claimed in claim 1, wherein the temporal reception-impossible state is a state where the MS temporarily cannot receive a Slow Associated Control Channel (SACCH) block.

3. The apparatus as claimed in claim 1, wherein the MS determines the temporal reception-impossible state when a user sets the temporal reception-impossible state.

4. The apparatus as claimed in claim 1, wherein the MS determines the temporal reception-impossible state according to whether a RX_LEVEL rapidly falls below a threshold value.

5. The apparatus as claimed in claim 1, wherein, if the preset time periods is exceeded, the MS increases or decreases the RLT value according to whether a SACCH block has been successfully received.

6. The apparatus as claimed in claim 5, wherein, if the call is released, the MS increases or decreases the RLT value according to whether a SACCH block has been successfully received.

7. The apparatus as claimed in claim 6, wherein the call is released at a user's communication termination request.

8. The apparatus as claimed in claim 6, wherein the call is released to free network resources when data are not received from the MS during the preset time period.

9. The apparatus as claimed in claim 1, wherein the MS reports the temporal reception-impossible mode to the network through a measurement report message.

10. The apparatus as claimed in claim 9, wherein the MS inserts RLT value maintenance time for the temporal reception-impossible mode into a predetermined portion of the measurement report message, instead of information on a near cell.

11. A method for preventing a call from being dropped in a mobile communication system, the method comprising:
reporting by a Mobile Station (MS) a temporal reception-impossible mode to a network if the MS enters a temporal reception-impossible state when a call has been connected, and maintaining a Radio Link Timeout (RLT) value during a preset time period; and
maintaining by the network the call with the MS during a preset time period after the temporal reception-impossible mode is reported from the MS.

12. The method as claimed in claim 11, wherein the temporal reception-impossible state is a state where the MS temporarily cannot receive a Slow Associated Control Channel (SACCH) block.

13. The method as claimed in claim 11, further comprising, when a user sets the temporal reception-impossible state, determining by the MS the temporal reception-impossible state.

14. The method as claimed in claim 11, further comprising determining by the MS the temporal reception-impossible state according to whether a RX_LEVEL rapidly falls below a threshold value.

15. The method as claimed in claim 11, further comprising, if the preset time period is exceeded, increasing or decreasing by the MS the RLT value according to whether a SACCH block has been successfully received.

16. The method as claimed in claim 15, further comprising, if the call is released, increasing or decreasing by the MS the RLT value according to whether the SACCH block has been successfully received.

17. The method as claimed in claim 16, wherein the call is released at a user's communication termination request.

18. The method as claimed in claim 16, wherein the call is released to free network resources when data are not received from the MS during a preset time period.

19. The method as claimed in claim 11, wherein the MS reports the temporal reception-impossible mode to the network through a measurement report message.

20. The method as claimed in claim 19, wherein the MS inserts RLT value maintenance time for the temporal reception-impossible mode into a predetermined portion of the measurement report message, instead of information on a near cell.

21. A method for preventing a call of a Mobile Station (MS) from being dropped in a mobile communication system, the method comprising:
determining if the MS enters a temporal reception-impossible state when a call has been connected;
reporting a temporal reception-impossible mode to a network if the MS enters the temporal reception-impossible state; and
maintaining a Radio Link Timeout (RLT) value during a preset time period in the temporal reception-impossible mode.

22. The method as claimed in claim 21, wherein the determining step comprises:
determining if a user sets the temporal reception-impossible state; and
if the user sets the temporal reception-impossible state, determining a current state as the temporal reception-impossible state.

23. The method as claimed in claim 21, wherein the determining step comprises the:
determining if a RX_LEVEL rapidly falls below a threshold value; and
if the RX_LEVEL rapidly falls below the threshold value, determining a current state as the temporal reception-impossible state.

24. The method as claimed in claim 21, wherein the reporting step comprises:
setting a value, which indicates the temporal reception-impossible mode, in an empty space of a measurement report message;
inserting RLT value maintenance time for the temporal reception-impossible mode into a predetermined portion of the measurement report message, instead of information on a near cell ; and
transmitting the measurement report message including the value and the RLT value maintenance time to the network.

25. The method as claimed in claim 21, further comprising, if the preset time period is exceeded, increasing or decreasing the RLT value according to whether a SACCH block has been successfully received.
